(19) United States
(12) Patent Application Publication
(10) Pub. No.: US 2004/0244131 A1
(43) Pub. Date: Dec. 9, 2004

(54) Quick disconnect swivel connector for multiple cleaning devices

(76) Inventor: Simon Ralph Cassar, Watsonville, CA (US)

Correspondence Address: SIMON CASSAR, 2431 TUCKAHOE TERRACE, WATSONVILLE, CA, 95076, US

(21) Appl. No.: 10/859,714

(22) Filed: Jun. 3, 2004

Related U.S. Application Data
(60) Provisional application No. 60/476,735, filed on Jun. 5, 2003.

(51) Int. Cl. B25G 3/00

(52) U.S. Cl. 15/144.2; 15/144.1

(57) ABSTRACT

An adjoined two-sectional swivel type floor cleaning attachment in which one section is made from a unitary flexible elastomer material allowing for a quick release clamp mechanism and the other section is adjoined by an axis that retains the handle allowing for swivel movement. The combination of the quick release unitary flexible clamp mechanism adjoined to a swivel mechanism allows for small cleaning devices, such as scrub brushes, wall washers, abrasive pad holders, etc. to be easily engaged and disengaged allowing the cleaning device to also be used as a hand held device. Furthermore, swivel type floor cleaning devices will no longer need their own swivel type connector affixed onto the cleaning head thus making the cleaning products more cost efficient.

### BACKGROUND OF THE INVENTION

1. Background of the Invention

The present invention relates to a scrubbing, dust mopping, or a sweeping apparatus and in particular to scrub brushes or applications where material is being removed by an apparatus. The present invention relates to a swivel joint adjoined two-sectional unitary flexible molded elastomer attachment that allows multiple cleaning apparatuses to be attached and detached for cleaning purposes. The new innovation allows for easy engagement and disengagement of the swivel mechanism to the cleaning head apparatus thus eliminating costly swivel joints that are adjoined to prior art swivel joint type cleaning apparatuses. In addition, allowing swivel connector to disengage from the cleaning head apparatuses, allows for the cleaning apparatuses to also be used as a hand held cleaning apparatus. In addition, using an elastomer material for the unitary jaw type connector that encompasses the swivel axis allows for the jaws to be preloaded thus the swivel does not become loose.

2. Description of Prior Art

The standard swivel type floor cleaning apparatus for scrub brushes and smaller cleaning apparatuses has two primary components. The first component is the floor cleaning head such as a wall washer, grout cleaner, scrub brush, and abrasive pad holder. All these floor-cleaning apparatuses have an adjoined embodied swivel type connector that is permanently attached to the cleaning apparatus making them very costly. The second primary component of floor cleaning apparatuses is the handle which is usually a cylindrical pole that is inserted into the swivel joint handle connector. The floor handle is only removable by unthreading a lock nut or twisting the handle out of the handle connector leaving the swivel joint mechanism attached to the cleaning apparatus. The prior art swivel type mechanism permits all floor cleaning apparatuses to be pushed and pulled by the exertion of a force on the handle and flex when coming in contact with obstacles. Prior art has also addressed the issue of loose swivels as in U.S. Pat. No. 4,763,377.

One significant problem with swivel type floor cleaning apparatuses that are used to adjoin a cleaning apparatuses like scrub brushes, wall cleaning, abrasive pad holders, flat wet mops and small dust mops are they come attached to the cleaning apparatus making the cleaning apparatus costly to manufacture. Such is the case in prior art U.S. Pat. No. 4,763,377. Also, the cleaning apparatus can only be used for floor cleaning due to the large swivel joint adjoined to the cleaning apparatus. Prior art such as “Flexible Elastomer Floor Dust Mop Attachment”, U.S. Pat. No. 6,237,182 does allow for easy disengagement and does preload the axis due to the elastomer material wrapping around the axis, but due to its flexible joint between the clamp and the handle connector, verses a swivel type joint, the flexible member does not allow for small cleaning device such as scrub brushes and other small cleaning apparatuses to lay flat on the ground during the cleaning operation and instead part of the scrub brush is lifted up when the flexible joint is pivoted. Simply put, the flexible joint acts as a spring action causing the floor cleaning apparatus to lift up on the opposing side of the pivoting action. On large dust mops this is not so evident, but on smaller cleaning apparatuses such as a scrub brush, wall washers and small dust mop frames this is unfortunately extremely apparent. Also, the flexible joint cannot allow for the swivel movement to become fixed and not flex when cleaning areas that do not require the cleaning apparatus to swivel but instead to remain stationary. However, the present invention allows for the scissor type swivel movement to be jammed by the use of a pin or bolt thus stopping the swivel movement. Other disengagement type swivel joints like Large dust mop frames do have disconnecting swivel joints like U.S. Pat. No. 5,901,402 but due to the large size of the connector, multiple parts causing looseness when attached to a small cleaning device they are not functional. Also, prior art U.S. Pat. No. 4,763,377 prevents loose swivels but is not as cost effective due to the swivel joint being attached directly to the cleaning apparatus thus making the product more costly.

Therefore, a significant need exists to improve upon the previous patents that allows for a more cost effective unitary elastomer non-loosening swivel type floor connector that can be easily detached from multiple small cleaning apparatuses making them more cost effective. Also, allowing small cleaning apparatuses to be used for hand cleaning operations thus reducing cost and space.

### SUMMARY OF THE PRESENT INVENTION

The present invention is a removable elastomer swivel type mechanism that is adjoined to a handle. The removable handle can be attached at the location between a handle and the head of the floor cleaning apparatus to provide a flexible member at the junction where the floor cleaning handle apparatus is attached to the floor cleaning apparatus head. Through use of the unitary elastomer clamp that adjoins to the swivel type connector member, when the floor cleaning apparatus head comes in contact with a stationary object the floor cleaning apparatus will flex beyond 90 degrees deflection around the longitudinal axis in relation to the floor cleaning apparatus handle.

It is therefore an object of the present invention to provide an elastomer disengaging apparatus by which a floor cleaning apparatus can swivel without loosening dues to the elastomer properties and also be used for hand held operations that can be economically manufactured.

It is further object of the present invention to provide a swivel type scrub brush or small cleaning apparatus that does not require the swivel joint to be adjoined to the cleaning head thus reduce cost and that can be economically manufactured.

Further novel features and other objects of the present invention will become apparent from the following detailed description, discussion and the appended claim, taken in conjunction with the drawings.

### BRIEF DESCRIPTION OF THE DRAWINGS

Referring particularly to the drawings for the purpose of illustration only and not limitation, there is illustrated:

FIG. 1. Is a perspective view of the preferred embodiment of the present invention floor cleaning handle apparatus attached to the floor scrub brush.

FIG. 2 is a perspective view of the preferred embodiment of the present invention floor-cleaning handle apparatus attached to the floor scrub brush.

FIG. 3. Is a cross-sectional view looking up taken along line 3-3 of FIG. 1.

FIG. 4. Is a front elevational view of the preferred embodiment of the present invention floor cleaning handle apparatus illustrating the movement of the attachment when in contact with a stationary object.

FIG. 5. Is a side elevational view of the preferred embodiment of the present invention floor cleaning handle apparatus.

FIG. 6. Is a side elevational view of the preferred embodiment of the present invention floor cleaning handle apparatus illustrating the movement of the elastomer hinge allowing an opening for the floor cleaning apparatus support frame to be attached.

FIG. 7. Is an isometric view of the floor cleaning handle apparatus in its entirety.

FIG. 8 Is a cross-sectional view looking down taken along line 8-8 of FIG. 1.

FIG. 9. Is an isometric view of the floor cleaning handle alternate attachment in its entirety.

FIG. 10. Is a cross-sectional view looking down taken along line 10-10 of FIG. 6.

FIG. 11. Is a perspective view of the jaw clamp preloaded onto the rotating shaft axis.

FIG. 12. Is a perspective view of the jaw clamp alternative preloaded onto the rotating shaft axis.

### DETAILED DESCRIPTION OF THE PREFERRED EMBODIMENT

Although specific embodiments of the invention will now be described with reference to the drawings, it should be understood that such embodiments are by way of example only and merely illustrative of but a small number of the many possible specific embodiments which can represent applications of the principles of the invention. Various changes and modifications obvious to one skilled in the art to which the invention pertains are deemed to be within the spirit, scope and contemplation of the invention as further defined in the appended claims.

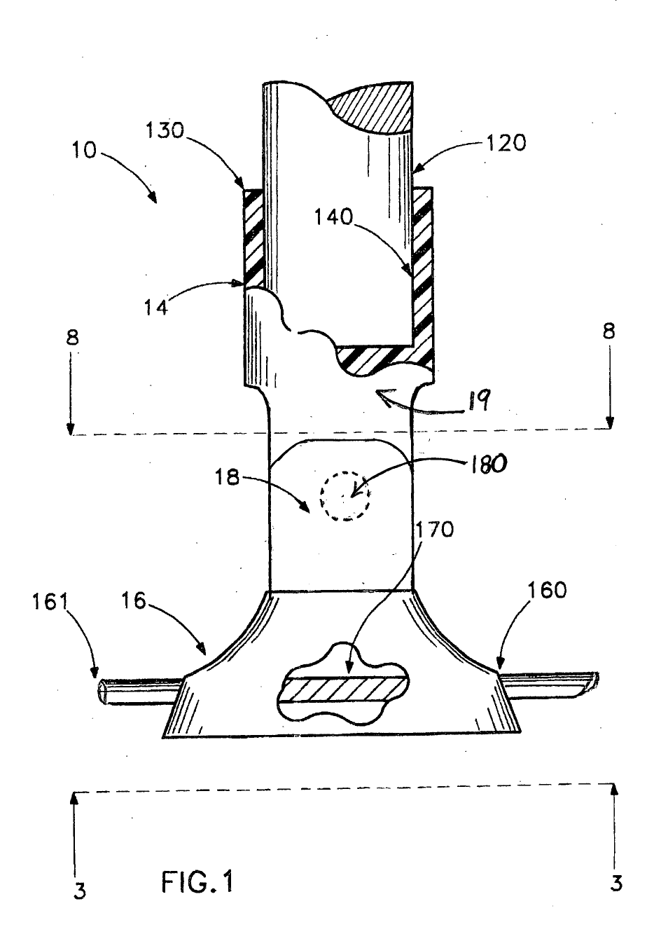

In the preferred embodiment, the insert member 10 in FIG. 1 is made of any flexible substance with memory such as rubber, urethane, nylon, plastic, titanium, polyvinyl. It is also within the spirit and scope of the present invention for the attachment to be made of flexible but strong plastic such as mylar, polypropolan or any other flexible material exhibiting the required characteristics.

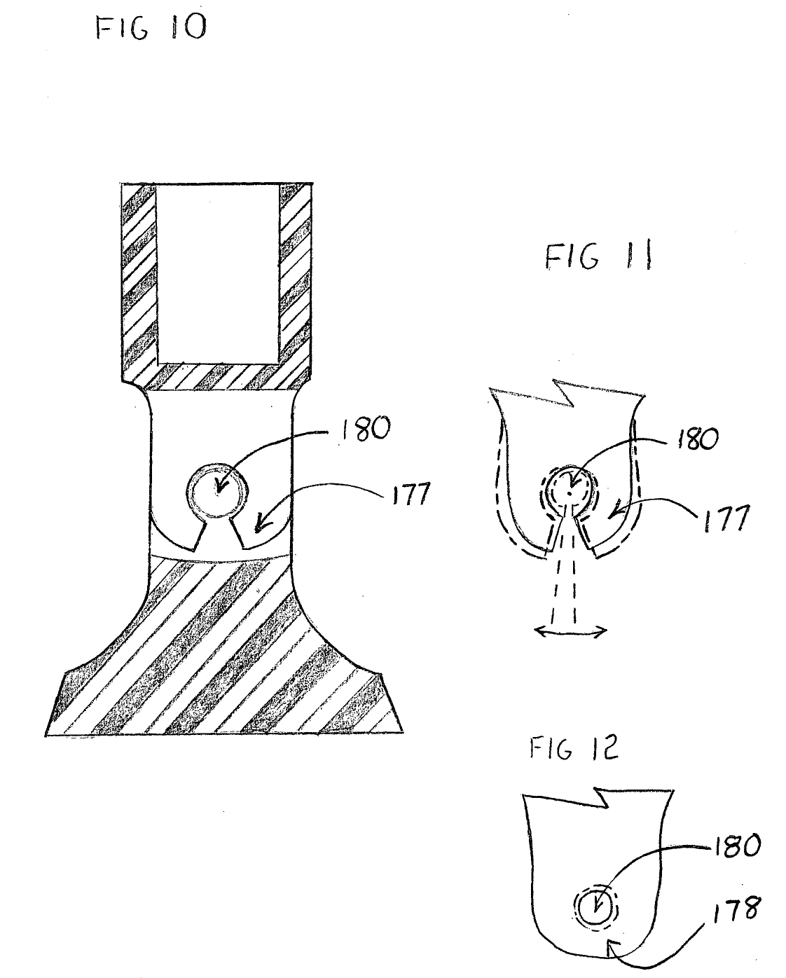

Referring to FIG. 1, there is shown at 10 the present invention swivel connector or multiple cleaning apparatuses. The apparatus is made from an elastomeric material comprised of two pieces upper support member 19 and lower support member 18 joined together at the rotating axis 180. It should be noted that the rotating axis is not limited to the type of axis used. For example the rotating axis member could be an integrally unitary molded shaft that makes up the lower support member 18 or could be a bolt, pin, fastener etc. In the preferred molded embodiment, the apparatus 10 comprises a longitudinal section 14 and a lateral section 16 that are interconnected by axis 180. as shown in cross sectional view FIG. 10. In general appearance, the two-piece molded inserts looks like an extended Roman numeral one with the top portion, item 130 being the receptacle to hold the handle 120. The handle is supported by the attachment body 14 that is a recessed cavity to hold the floor handle. Accordingly the upper sleeve portion of the cylindrical sleeve section 130 includes an axial bore 140 having a uniform dimension so as to receive therein the transverse dimension of the handle 120. The thickness of the material-encapsulating handle 120 is sufficient to not crack when impact to the head of the floor cleaning apparatus occurs. The upper sleeve section 130 has a diameter to tightly receive in a generally slip-fit relationship the transverse dimension of the handle to frictionally retain the handle therein. It is not limited to the intent of this invention as to how the handle is retained and can be either threaded or attached by a bolt or rivet. The overall configuration of the lower member 18 as it joins to the floor cleaning apparatus frame support clamp recess cavity 160 resembles an inverted “T” with the mid portion of the vertical leg being thin in the middle and the lower portion of the leg extending outboard in both the left and right lateral directions to form the clamp mechanism 16 as shown in FIG. 1 The clamp mechanism 16 when attached to the floor cleaning head support frame 170 retains the floor cleaning apparatus head. When the clamp mechanism

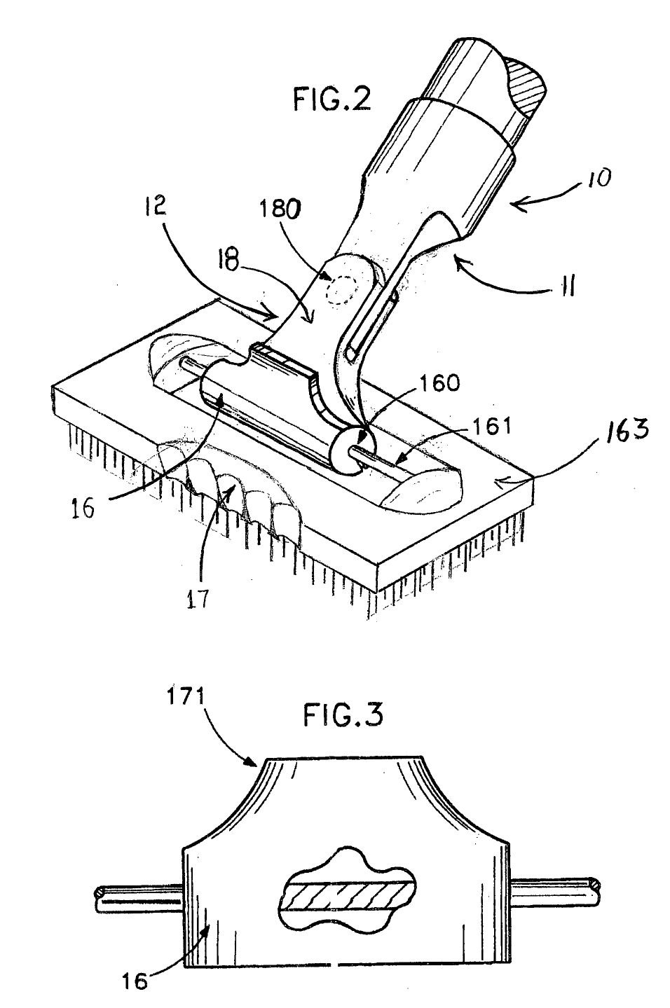

Referring to FIG. 2. there is illustrated in a perspective view the relationship between the perspective floor cleaning brush head 163 and floor cleaning handle attachment 10. The present invention includes a two sectional connector adjoined together through axis shaft 180. The lower section 12 comprising of a clamping mechanism section and a upper section 11 comprising of the handle support hole. Both sections are a one piece unitary molded part adjoined only be way of axis 80. The floor cleaning brush head support frame 161 is encapsulated by the clamp mechanism 16 and supported by the lateral recess cavity 160. The support frame 161 has a diameter between 0.25 to 0.50 of an inch. The larger diameter allows for the cleaning head to be a unitary one piece injected molded apparatus. The lower support member 18 adjoins the clamp mechanism 16. When the clamp mechanism 16 is disengaged from the support frame 170 the cleaning brush head 163 or cleaning head devices can be used as a hand held cleaning device using ergonomic hand hold 17.

Referring to FIG. 3. Illustrates the clamp mechanism 16 and the protruding push lever 171 that allows leverage to open the jaws of the clamp.

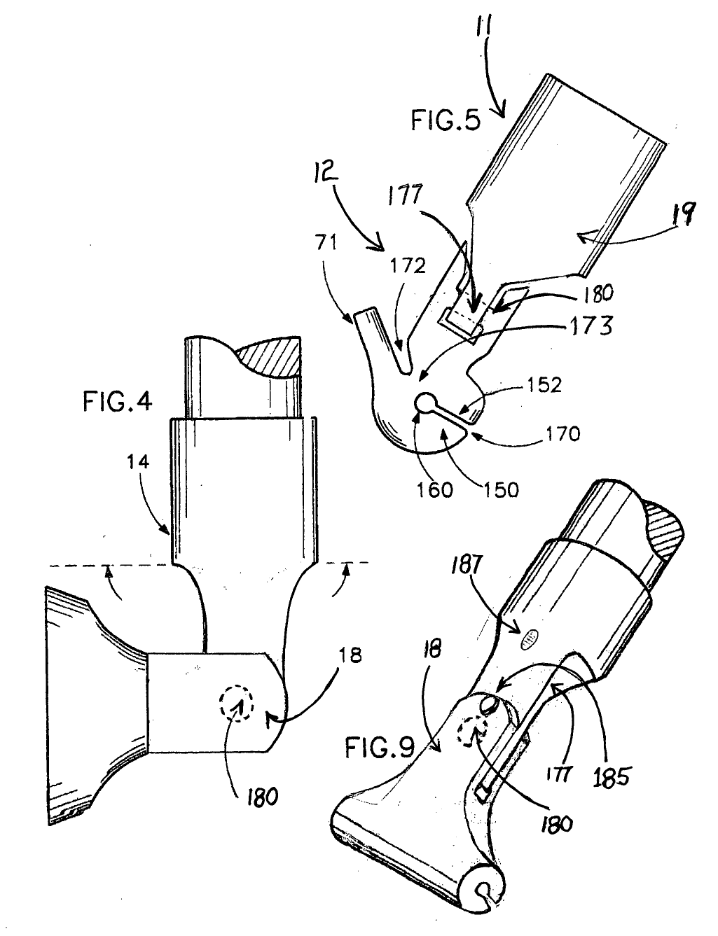

Referring to FIG. 4. Illustrates the movement of the swivel connector when in contact with a stationary object. The floor cleaning attachments lower support member 18 can rotate around the axis shaft 180 over 90 degrees in relation to the floor cleaning handle support 14.

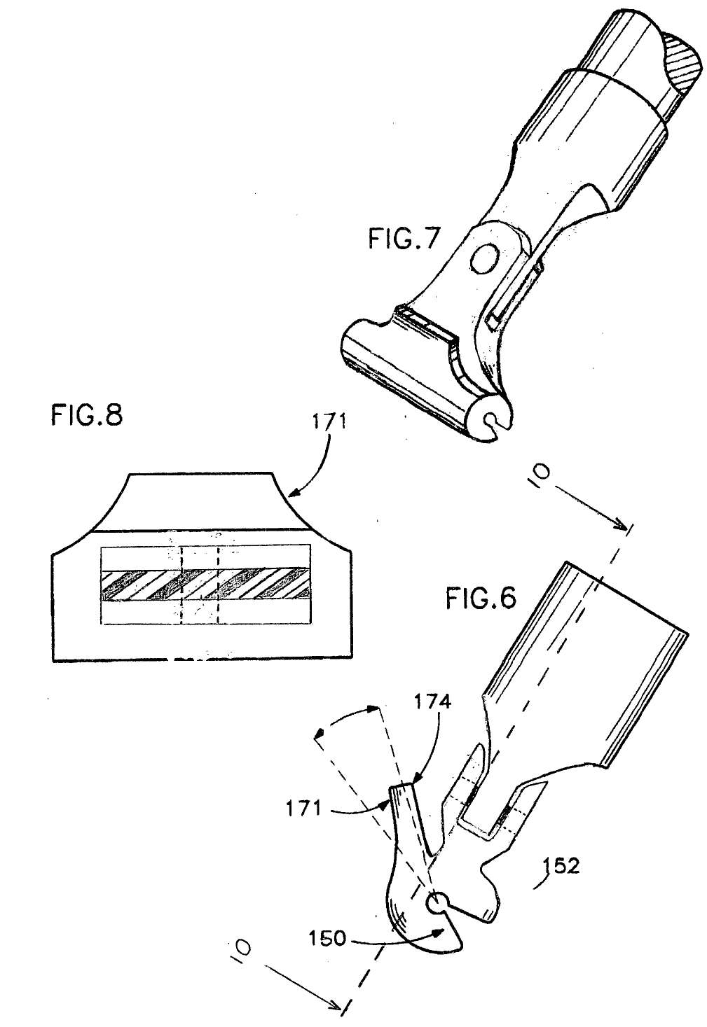

Referring to FIG. 5. there is Illustrates the unitary elastomeric clamp mechanism 12 and unitary handle support section 11. The clamp mechanism 16 has an upper jaw 152 and lower jaw 150 with an opening 170 that extends laterally. Opening 170 allows for access to cavity 160 that loosely supports the floor dust mop frame in order to pivot along the lateral axis. The upper clamp 152 remains rigid while the lower clamp 150 pivots around the lateral axis at 172. Protruded lever 171 when depressed displaces cavity 172 allowing for lower clamp 150 to move forward in relation to upper clamp 152 allowing for opening 170 to enlarge as shown in FIG. 6. Hinge 173 allows for a preload to occur around the clamping mechanism. The peripheral side arm type jaws 177, wrap around the axis shaft 180.

Referring to FIG. 6. there is Illustrated the movement of the clamp mechanism between upper and lower clamps 150 and 152 when force is applied to protruded lever 171 on side 174.

Referring to FIG. 7. there is an isometric illustration of the attachment in its entirety.

Referring to FIG. 8. there is Illustrated a cross sectional view with the flexible elastomeric material shaped as a rectangle. The purpose of a rectangular shape is to allow for maximum flexibility in the lateral movement yet retains rigidity in the forward and aft movement.

Referring to FIG. 9. there is shown an isometric illustration of an alternate embodiment of present invention without the protruding lever to ease in opening the clamp in its entirety. Also shown is jam pin 185 inserted into support member 18 and arm type jaws 177 to jam/stop the rotation of the swivel joint around axis 180. Storage hole 187 is shown that would house the jam pin 185 when normal swivel movement of the connector is required.

This alternative embodiment is identical for attaching the base of the apparatus to a floor cleaning device support frame that is illustrated in FIG. 9. The alternate attachment is identical to the previous attachment described except has no protruding lever 171. However, there is still the open recessed cavity 172 as depicted in FIG. 5 that allows for ease of installing the attachment onto the floor cleaning apparatus frame. To install the alternate embodiment, the operator must apply force to press on the attachment onto the floor dust mop frame.

Referring to FIG. 10. there is Illustrated a cross sectional view of the attachment in its entirety, The peripheral symmetrical side arm type jaws 177, preloaded and wrapped around the unitary elastomer expandable axis shaft 180.

Referring to FIG. 11. there is illustrated a section view of the peripheral symmetrical arm type jaws 177 revealing the preload movement once inserted onto the expandable elastomer axis shaft 180. The preloaded jaws 177 around expandable elastomer shaft 180 eliminates wobble and excessive movement of the cleaning head during a cleaning operation.

Referring to FIG. 12. there is illustrated an alternate embodiment 178 that encapsulates axis shaft 180. The hole size for shaft 180 will be undersized causing a preload condition to eliminate wobble during a cleaning operation. This method would allow for a pin, fastener or bolt to attach the upper and lower members together.

Defined broadly, the present invention is a two-piece swivel type floor cleaning attachment that can easily be engaged or disengaged to small cleaning apparatuses, such as scrub brushes, allowing for hand operation of prior art floor-cleaning apparatuses.

Therefore, through use of the present invention, a swivel type attachment can be easily engaged or disengaged and not be affixed onto floor cleaning apparatuses can now be manufactured that is economical, and can be also used as a hand held cleaning device since a u-joint or other type swivel attachments are no longer needed to be affixed to the cleaning head device.

Of course the present invention is not intended to be restricted to any particular form or arrangement, or any specific embodiment disclosed herein, or any specific use, since the same may be modified in various particulars or relations without departing from the spirit or scope of the claimed invention herein above shown and described of which the apparatus shown is intended only for illustration and for disclosure of an operative embodiment and not to show all of the various forms or modification in which the invention might be embodied or operated.

The invention has been described in considerable detail in order to comply with the patent laws by providing full public disclosure of at least one of its forms. However, such detailed description is not intended in any way to limit the broad features or principles of the invention, or the scope of patent monopoly to be granted.

What I claim as my invention is:

1. A cleaning head apparatus, comprising:
a. a cleaning head member having a top mounting surface and a bottom cleaning surface, the top mounting surface having a support frame thereto;
b. a two sectional swivel joint handle attachment adjoined together around an axis whereas one of the two sections is a unitary clamp mechanism made from an elastomer material having a flexible transverse clamping section that can engage and disengage from a cleaning apparatus support frame. The other section being a longitudinal attachment section having an axial bore with and open end to receive a handle and the other end having an opening to receive the said axis to allow for swivel movement;
c. Said unitary flexible transverse clamping section having an upper jaw and a lower jaw, whereas the upper and lower jaws form a slotted opening which interconnects with a retaining cavity for receiving the support frame and the other end having an axis for the said longitudinal handle support that engages the axis allowing rotation around the vertical axis by means of a pivotal member.
d. A push lever integrally formed with said lower jaw such that when the push lever is forced inwardly, said lower jaw moved away from said upper jaw for allowing said support frame of said cleaning head member to be inserted through said slotted opening and secured within said retaining cavity when the push lever is released allowing the cleaning head device to be used independently as a hand held cleaning device without the interference of a swivel type joint mechanism adjoined to the cleaning head;
e. Said support frame to be a diameter between 0.10 to 1.5 of an inch in diameter allowing for a one-piece injection molded cleaning head device.
f. Said longitudinal attachment section having an axial bore with and open end to receive a handle and the other end having an opening to receive the said axis to allow for swivel movement;
g. Said longitudinal member having one end press fitted from said open end and secured within said axial bore of said attachment section of said swivel rotating attachment member;
h. Said swivel rotating connecting section having an axes in which the said axis clamping section and said longitudinal attachment section can rotate around to allow the lateral rotation of said cleaning head devices.
i. Whereby said swivel attachment member allows said handle member to maneuver said cleaning head member to be pushed back and forth while at the same time allows said handle member to move laterally relative to said cleaning head member and when said cleaning head member comes in contact with an object, said swivel connecting section allows lateral rotation of said cleaning head member.
j. The pivotal lateral support member is made from any type of flexible material that allows friction between the lateral support bar and the opening jaws of the quick release connector. The preloaded flexible member provides resistance to pivotal movement of the holding member and the connecting member. The resistance to pivotal movement is due to the one end of the universal joint being made of a flexible type material needed for the opening of the clamp mechanism

2. A swivel cleaning attachment in accordance with claim 1, wherein said clamping member is made our of elastomer material.

3. The swivel cleaning attachment in accordance with claim 1, wherein said flexible attachment member clamp and said axis and clamping sections are made out of a compressible expandable elastomer material to allow preload gripping interference force.

4. A swivel cleaning attachment in accordance with claim 1, wherein said clamping member rotates around said axis member can be jammed to stop the swiveling motion by way of a pin inserted into the two scissor like members and the pin stored in another location of the connector for easy retrieval when not in use.

5. An attachment member to be used in conjunction with a cleaning head device having a handle and a laterally disposed cleaning head with a bottom cleaning surface and a top mounting surface having a support frame, the attachment member comprising:
a. a two piece attachment member having a transverse clamping section, a longitudinal attachment section and a swivel connecting section adjoining the clamping section and the attachment section.
b. Said clamping section having an upper jaw and a lower jaw, where the upper and lower jaws form a slotted opening which interconnects with a retaining cavity for receiving the support frame;
c. Means for forcing either one of said upper and lower jaws away from the other one of said upper and lower jaws for allowing said support frame of said cleaning head to be inserted through said opening and secured with said retaining means;
d. Said longitudinal attachment section having an axial bore with and open end;
e. An elongated handle member having one end press fitted from said open end and secured within said axial bore of said attachment section of said swivel rotating attachment member;
f. Said swivel rotating connecting section having an axes in which the said axis clamping section and said longitudinal attachment section can rotate around to allow the lateral rotation of said cleaning head devices.
g. Whereby said swivel attachment member allows said handle member to maneuver said cleaning head member to be pushed back and forth while at the same time allows said handle member to move laterally relative to said cleaning head member and when said cleaning head member comes in contact with an object, said swivel connecting section allows lateral rotation of said cleaning head member.

6. A swivel cleaning attachment in accordance with claim 4, wherein said clamping member and attachment material is made out of elastomer material.

7. The swivel cleaning attachment in accordance with claim 4, wherein said flexible attachment member clamp and said axis clamping section is made out of an elastomer material to allow preload gripping interference force.

8. The attachment member in accordance with claim 4, wherein said means for forcing either one of said upper and lower jaws away from the other one of said upper and lower includes a push lever integrally formed with said lower jaw such that when the push lever is forced inwardly, said lower jaw moves away from said upper jaw for allowing said support frame of said dust mop head member to be inserted through said opening and secured within said retaining means when push lever is released.

9. The attachment member in accordance with claim 4 wherein said retaining means includes a cavity.
